(19) United States
(12) Patent Application Publication
(10) Pub. No.: US 2011/0191481 A1
(43) Pub. Date: Aug. 4, 2011

(54) SYSTEMS AND METHODS FOR TRANSFERRING DATA

(75) Inventors: D. Martin Swany, NEWARK, DE (US); Ezra D. Kissel, BREINIGSVILLE, PA (US)

(73) Assignee: UNIVERSITY OF DELAWARE, NEWARK, DE (US)

(21) Appl. No.: 13/020,395

(22) Filed: Feb. 3, 2011

Related U.S. Application Data
(60) Provisional application No. 61/301,033, filed on Feb. 3, 2010.

(51) Int. Cl. G06F 15/16

(52) U.S. Cl. 709/227

(57) ABSTRACT

Data transfer systems and methods are disclosed. A method of transferring data includes initiating a session for transferring data, establishing a session connection between a first gateway and a second gateway, buffering a predetermined amount of data received by the first gateway, generating a data block using a session-layer protocol when the predetermined amount of data is buffered, and transmitting the data block from the first gateway to the second gateway over the session connection. A system for transferring data includes a first gateway, a second gateway, and a network. The first gateway includes memory for buffering received data and a processor operable to execute a session-layer protocol for generating a data block when a predetermined amount of data is buffered. The first gateway is configured to transmit the data block to the second gateway via the network during a session.

### CROSS REFERENCE TO RELATED APPLICATIONS

This application claims priority to U.S. patent application No. 61/301,033, entitled “SESSION-LAYER BURST SWITCHING,” filed on Feb. 3, 2010, the contents of which are incorporated herein by reference.

### FIELD OF THE INVENTION

The present invention relates generally to data transfer systems and methods, and more particularly, to session layer-implemented data transfer systems and methods.

### BACKGROUND OF THE INVENTION

Data transfer systems and methods have been increasingly relied upon to transfer large amounts of data across computer networks. Important characteristics of conventional data transfer systems include reliable, accurate data transfer as well as high-speed data transfer.

While network technology and available bandwidth have increased in recent years, the data transfer speeds of conventional data transfer systems have not increased at a corresponding rate. Accordingly, improved data transfer systems are desired.

### SUMMARY OF THE INVENTION

The present invention is embodied in data transfer systems and methods.

In accordance with one aspect of the present invention, a method of transferring data is disclosed. The method comprises the steps of initiating a session for transferring data, the session having a session-layer protocol, establishing a session connection between a first gateway and a second gateway, buffering a predetermined amount of data received by the first gateway, generating a data block using the session-layer protocol when the predetermined amount of data is buffered, the data block including the buffered data, and transmitting the data block from the first gateway to the second gateway over the session connection.

In accordance with another aspect of the present invention, a system for transferring data is disclosed. The system comprises a first gateway, a second gateway, and a network. The first gateway is operable to initiate a session for transferring data and receive data to be transferred. The first gateway includes memory for buffering the received data and a processor operable to execute a session-layer protocol for generating a data block including the buffered data when a predetermined amount of data is buffered. The network connects the first gateway and the second gateway. The first gateway is configured to transmit the data block to the second gateway via the network during the session.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a block diagram illustrating an exemplary data transfer system in accordance with aspects of the present invention;

FIG. 2 is a flow chart illustrating an exemplary data transfer method in accordance with aspects of the present invention; and

FIG. 3 is a block diagram illustrating an exemplary algorithm for generating a data block in accordance with aspects of the present invention.

### DETAILED DESCRIPTION OF THE INVENTION

The exemplary systems and methods disclosed herein are broadly usable for transferring data between networked computers. The disclosed systems and methods may be incorporated into conventional data transfer systems via software and/or hardware modifications that will be understood to one of ordinary skill in the art from the description herein. As set forth herein, the exemplary systems and methods disclosed herein may be particularly suitable for improving data transfer performance, and increasing network efficiency.

Aspects of the present invention are directed to optimizing data movement in networks with high bandwidth-delay products, e.g. high-speed wide-area networks. Conventional network protocols and devices hold data in very small data units, e.g. packets, which may consist of between 40 bytes and 9 kilobytes, for example. The disclosed systems and methods include significant storage in network devices, e.g. gateways, to be used as data buffers. As these buffers are filled, dynamic network resource allocation can occur so that the buffered data is rapidly streamed to the buffer of another gateway close to the receiver, or directly to the receiver itself. The disclosed systems and methods utilize a novel session-layer protocol that makes use of a variety of transport-layer protocols and dynamic network allocation technologies. These dynamic network allocation technologies include, for example, Resource Reservation Protocol (RSVP), Differentiated Services (DiffServ), Multiprotocol Label Switching (MPLS), and Generalized Multiprotocol Label Switching (GMPLS), as well as mechanisms like Web Services.

Aspects of the present invention are directed to effectively using dynamic networks. In dynamic networks, dedicated network resources may be requested and reserved on-demand. The disclosed systems and methods may use dynamic networks more effectively than conventional data transfer systems by using a session layer protocol to manage the end-to-end connection across the dynamic network. The session layer protocol maintains the end-to-end connection by binding together multiple transport layer connections and protocols, including both permanent and temporary layer 3 (i.e. network layer) and layer 2 (i.e. data link layer) links.

The disclosed systems and methods also desirably utilize dedicated channels and resources, such as bandwidth dedication. A dedicated channel may take the form of MPLS tunnels, virtual LANS, synchronous optical networking (SONET) timeslots, or dedicated dense wavelength division multiplexing (DWDM) lambdas. A dedicated network channel may allow the use of efficient protocols, including application-controlled user datagram protocol (UDP) bursts, rate-based transport protocols and even emerging standards such as remote direct memory access (RDMA) over Converged Ethernet (RoCE). The systems and methods described herein may utilize any of a family of transports and link layer protocols in order to minimize overhead and maximize channel utilization. The dedicated networks could be any sort of differentiated service tunnel, or optical link such as those in passive optical networks (PONs). The systems and methods described herein may be particularly well-suited for use within emerging long-reach passive optical networks (LR-PONs) in which it could be possible to enable coarse-grained scheduling of multiplexed data bursts over passively switched, high-capacity optical paths.

As set forth below, the disclosed systems and methods form blocks of data at transport-layer gateways in the network, instead of reserving a dedicated “circuit” per application. The systems and methods are then able to intelligently schedule and switch these blocks of data in bursts along allocated network paths as they become available. Using session-layer protocol data units, referred to herein as data blocks, significant amounts of data may be buffered. As set forth herein, the data block comprises the basic unit of data that is transferred along the network core. Subsequently, data block formation, size, scheduling, and flow control are all subject to allocation time, the current state of the core network, and the policies enforced by the network devices such as gateways. This allows the burst size to be adapted to the characteristics of the network path and optimally transferred via explicit buffers negotiated between gateways. This data bursting may provide benefits over conventional data transfer systems by amortizing overheads over a large data transfer, including overheads from the protocol and from channel arbitration.

The exemplary systems and methods described herein are implemented by session-aware, transport-layer gateways. These gateways allow a user to adapt or change transport protocols, thereby effecting tuning specific to network segments. By providing these gateways with significant buffering resources, the disclosed systems and methods enable the asynchronous transfer of larger amounts of data (e.g., data blocks) for better utilization of lossless links and improved overall throughput.

Further, the gateways disclosed herein may control core network links, and can be used for flow control outside of the network band, on a session-based control channel. This may allow for the utilization of open-loop flow control over these long distance, high-bandwidth links. With the exemplary systems and methods described herein, flow control may be managed at a much coarser granularity, and traffic no longer need be statistically multiplexed. Instead, the bandwidth for a data burst over a dedicated channel may be guaranteed for a certain size and a certain time slot, as will be discussed herein. An open loop model over the core may enable the determination ahead of time of what resources are necessary and to pace burst data transfers based on buffer and throughput capabilities at various points in the network.

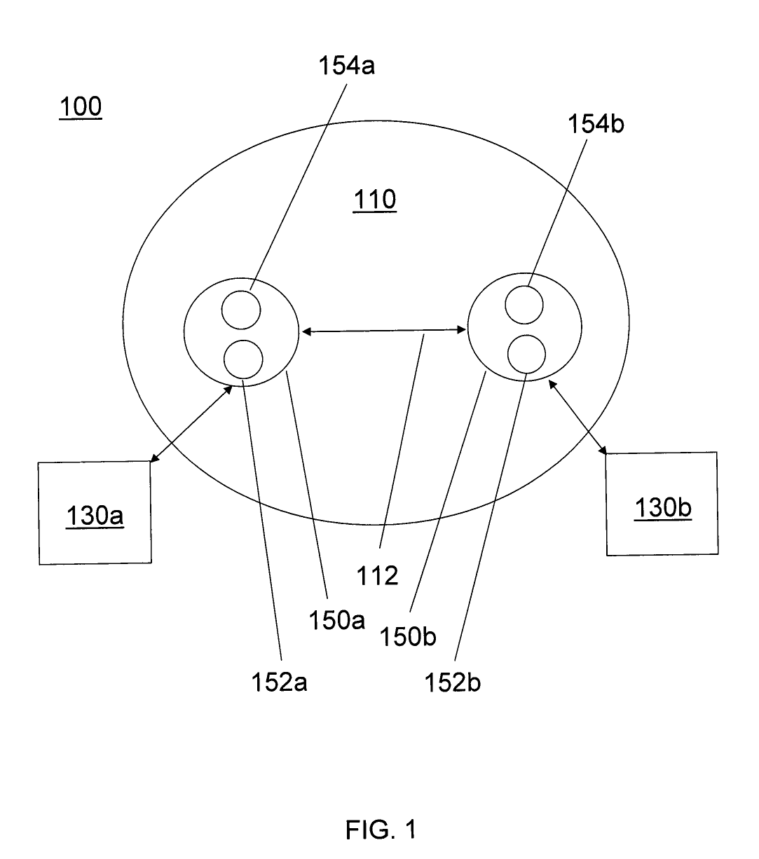

Referring now to the drawings, FIG. 1 illustrates an exemplary data transfer system 100 in accordance with aspects of the present invention. Data transfer system 100 may be usable to transfer data between a pair of computers, e.g., a client computer and a server computer. As a general matter, data transfer system 100 includes a network 110, computers 130, and gateways 150. Additional details of data transfer system 100 are provided herein.

Network 110 provides connections for transferring data. In an exemplary embodiment, network 110 is a wide area network (WAN) or a local area network (LAN). Network 110 includes a plurality of network devices or nodes, including gateways 150a and 150b. While only one network connection 112 is shown in FIG. 1 (between gateways 150a and 150b), network 110 provides a plurality of distinct network paths between network devices. Network 110 may provide for data transfer between the plurality of network devices through hardwired or wireless network connections. Suitable networks for use with the present invention will be known to one of ordinary skill in the art from the description herein.

In a preferred embodiment, network 110 may be a dynamic network. In this embodiment, network 110 may be operable to set aside or allocate bandwidth in certain network paths for dedicated connections between network devices. Network 110 may allocate bandwidth on a temporary or permanent basis. Network 110 may allocate bandwidth to this dedicated connection when requested to do so by a network device, or when necessary based on the data to be transferred between network devices.

Computers 130 are connected via network 110. Computers 130a and 130b form the ends of the path of the data transferred by data transfer system 100. In an exemplary embodiment, computer 130a is a client computer, and computer 130b is a server computer. Computer 130a may formulate and transmit a request for data stored on computer 130b. This request may comprise a request to initiate a session between computer 130a and computer 130b. Once the session has been initiated, computer 130b may commence transferring the requested data to computer 130a via network 110. In an exemplary embodiment, computer 130b transmits the requested data to gateway 150b. Gateway 150b then transmits the data to gateway 150a, as will be described in more detail below. Computer 130a then receives the transferred data from gateway 150a. Suitable computers for use as computers 130 will be known to one of ordinary skill in the art from the description herein.

Gateways 150 are network devices within network 110. Gateways 150a and 150b are configured to transmit data between each other via a network connection 112 provided by network 110. While only one network connection 112 is illustrated, network 110 may provide a plurality of distinct network paths for transmitting data between gateways 150a and 150b.

Each gateway 150 desirably includes memory 152 for buffering data received from a computer 130 or another gateway 150. In accordance with aspects of the present invention, it is desirable that gateways 150 include sufficient memory 152 to buffer a relatively large amount of data, e.g., tens of gigabytes (GBs). This may be particularly useful for transmitting bursts of large data blocks, as will be described in greater detail herein. In an exemplary embodiment, memory 152 is Dynamic RAM (DRAM). Alternatively, memory 152 may be, for example, solid state disks. Suitable memories for use as memory 152 will be known to one of ordinary skill in the art from the description herein.

Each gateway 150 also desirable includes a processor 154. Processor 154 is programmed to execute the functions performed by gateways 150. For example, processor 154 may be programmed to initiate a session between computers 130, execute a session-layer protocol to process data received by the gateway 150, and/or establish a network connection to another gateway 150. It will be understood to one of ordinary skill in the art that the above-described functions of processor 154 are included solely for the purposes of illustration, and are not intended to be limiting.

In an exemplary embodiment, each gateway 150 may be a computer, server, router, modem, or other similar device configured to transmit and receive data, and perform the functions described herein with respect to gateways 150. Suitable devices for use as gateways 150 will be known to one of ordinary skill in the art from the description herein.

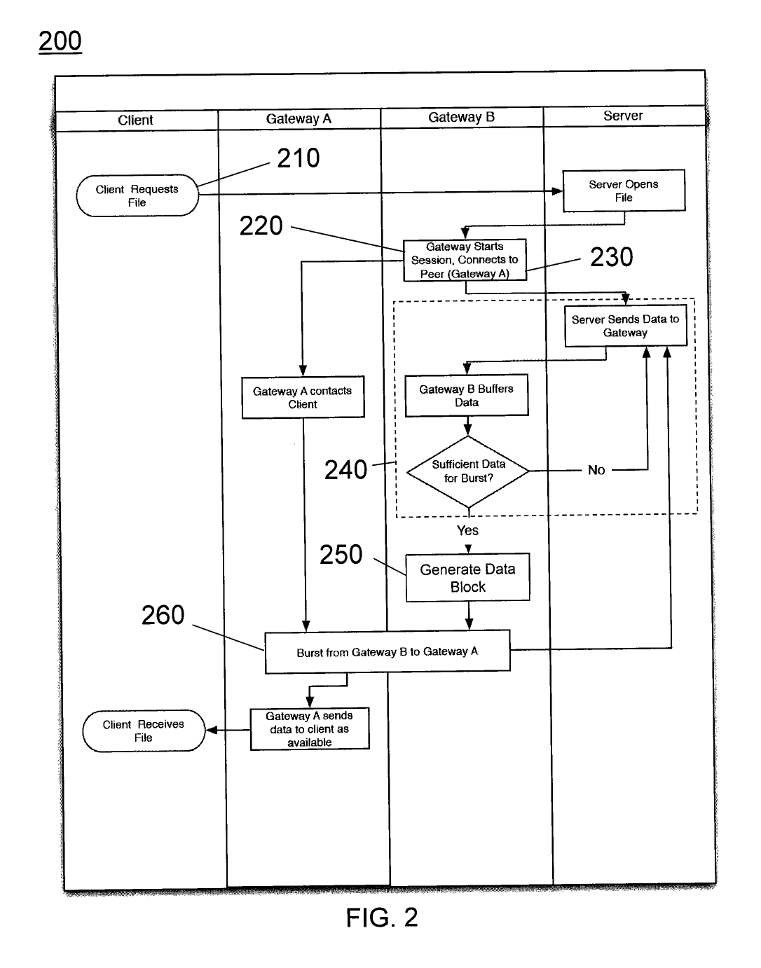

FIG. 2 illustrates an exemplary data transfer method 200 in accordance with aspects of the present invention. Data transfer method 200 may be usable to transfer data between a pair of computers, e.g., a client computer and a server computer. Generally, data transfer method 200 includes the steps of initiating a session, establishing a session connection, buffering a predetermined amount of data, generating a data block using a session-layer protocol, and transmitting the data block. Additional details of data transfer method 200 are provided herein. For the purposes of illustration, the steps of data transfer method 200 are described herein with reference to the exemplary data transfer system 100 described above.

In step 210, a client requests the transfer of data from a server. In an exemplary embodiment, client computer 130a transmits a request for data transfer from server computer 130b via network 110. The request from client computer 130a may comprise a request to initiate a session for transferring data between client computer 130a and server computer 130b. The request may identify the server computer 130b from which the data is requested, and the specific data requested. The session maintains an end-to-end connection between client computer 130a and server computer 130b by binding together multiple transport layer connections and protocols, including both permanent and temporary layer 3 (i.e. network layer) and layer 2 (i.e. data link layer) links.

In step 220, a session is initiated. In an exemplary embodiment, gateway 150b initiates a session for transferring data from computer 130b to computer 130a. The initiation of a session by a gateway 150 will be understood to one of ordinary skill in the art from the description herein. The session includes a session-layer protocol comprising instructions or commands to gateway 150b for transferring the data. The instructions or commands included in the session-layer protocol will be clear to one of ordinary skill in the art from the description of method 200 set forth herein.

The session desirably contains the context for the end-to-end connection, and provides for key protocol issues like end-to-end integrity assurance. The session-layer protocol manages explicit communication with, and among, the session gateways.

In step 230, a session connection is established. In an exemplary embodiment, gateway 150b establishes a network connection 112 with gateway 150a via network 110 in conjunction with the initiation of the session. The network connection 112 may comprise one or more network paths for enabling the transfer of data between gateways 150a and 150b.

In step 240, a predetermined amount of data is buffered. In an exemplary embodiment, gateway 150b receives the data to be transferred from computer 130b. Gateway 150b may receive the data to be transferred as an intermittent or continuous stream of data. As gateway 150b receives the data to be transferred, gateway 150b buffers the received data in memory 152b. Notably, gateway 150b does not transfer the data received from computer 130b at this time. Gateway 150b continues to buffer the data received from computer 130b until a predetermined amount of data has been buffered.

In step 250, a data block is generated. In an exemplary embodiment, the session-layer protocol comprises instructions for generating a data block from the data buffered by gateway 150b. Gateway 150b does not generate the data block until the predetermined amount of data has been buffered. For example, gateway 150b may generate the data block using the session-layer protocol when at least 100 megabytes (MBs) of data are buffered by gateway 150b.

Selection of the predetermined amount of buffered data may be based on the available bandwidth in the network connection 112 between gateway 150b and gateway 150a. Where network 110 is a dynamic network that employs dynamic network resource allocation, the predetermined amount of data may also desirably be dynamic. For example, when a large amount of bandwidth is allocated to network connection 112 (e.g., 10 GB/sec), the predetermined amount of buffered data may be relatively high (e.g., greater than 1 GB). Conversely, when a small amount of bandwidth is allocated to network connection 112 (e.g., 100 MB/sec), the predetermined amount of buffered data may be relatively low (e.g., 100 MBs). Thus, the predetermined amount of buffered data may be varied dependent on the availability of network resources and/or bandwidth to transmit the buffered data, as well as the offered traffic load.

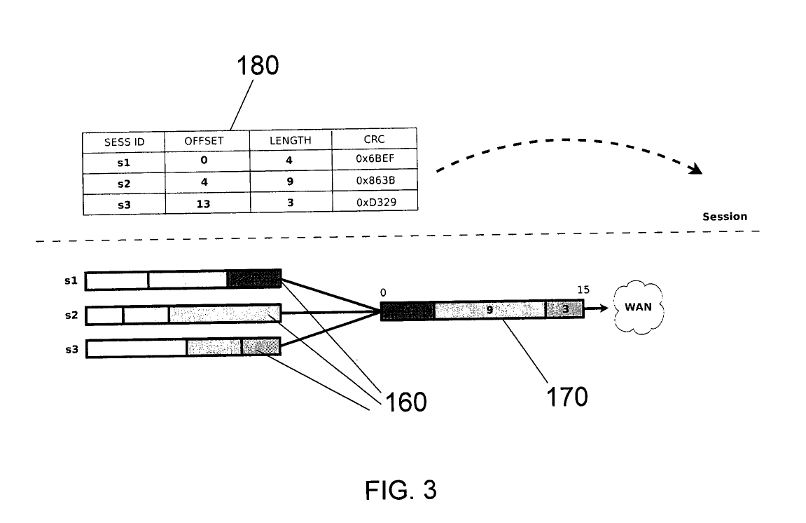

When the predetermined amount of data is buffered, gateway 150b proceeds with the generation of a data block that includes the buffered data. One exemplary method for generating a data block is described below for the purposes of illustration with respect to FIG. 3.

As shown in FIG. 3, gateway 150b may receive a plurality of individual data units 160 during a session. In an exemplary embodiment, data units 160 are packets of data. The data units 160 may correspond to a single session, or may correspond to multiple different sessions. When a predetermined number of data units 160 have been buffered by gateway 150b (corresponding to the predetermined amount of data), gateway 150b proceeds with the generation of a data block 170 from data units 160, pursuant to the session-layer protocol. Using the session-layer protocol, gateway 150b encodes at least a portion of the data from each data unit 160 (e.g., the user data in a packet) into a single data block 170 for eventual transmission via network 110. This encoding may comprise multiplexing the data from each data unit 160, as well as compression or coding for Forward Error Correction, for example. At this time, gateway 150b may also generate control information 180 about the data block 170 for use in decoding data block 170, as shown in FIG. 3. The control information 180 may include the number and total length of each data unit portion with the data block, an associated record for each data unit portion, offset data for the location of the data unit portion in the data block, and a CRC field including error correction data. The control information 180 may further include a session ID for each data unit portion, where the data block includes data from multiple different sessions.

In step 260, the data block is transmitted over the session connection. In an exemplary embodiment, gateway 150b transmits the data block to gateway 150a over network connection 112. Gateway 150b may transmit the data block as a burst of data across network connection 112, and may cease data transmission when the entire data block has been sent.

Transmission of the data block may be selected based on the available bandwidth in the network connection 112 between gateway 150b and gateway 150a. Where network 110 is a dynamic network that employs dynamic network resource allocation, the transmission of the data block may be dependent on the currently allocated network resources. For example, as memory 152b of gateway 150b becomes full, gateway 150b may request that network 110 allocate a large amount of bandwidth to network connection 112 (e.g., 10 GB/sec) in order to accommodate the burst of data during transmission of the data block. Conversely, before gateway 150b has buffered the predetermined amount, or after gateway 150b has transmitted the data block, network 110 may allocate little or no bandwidth to network connection 112, while network 110 waits for gateway 150b to generate another data block. Thus, the allocation of network resources may be time-sensitive and dependent on whether gateway 150b has generated or is about to generate a data block for transmission.

At this time, gateway 150b may also transmit the control information 180 to gateway 150a. In one embodiment, gateway 150b may transmit control information 180 via network connection 112. Alternatively, gateway 150b may transmit control information 180 out of band, e.g., over a connection separate from network connection 112. This may be particularly desirable in order to leave network connection 112 free to transmit the data block 170 without additional overhead. When gateway 150a has received both control information 180 and the data block 170, gateway 150 may use control information 180 to decode data block 170 (e.g., by demultiplexing) back into the individual data units, as shown in FIG. 3.

When gateway 150a receives the data block, gateway 150a may be configured to send an acknowledgement back over network connection 112, along with any information about data transfer errors that may have occurred during transmission of the data block. Gateway 150a may then transmit the requested data to computer 130a.

While the above described systems and methods relate to a session including only two gateways 150a and 150b, it will be understood by one of ordinary skill in the art from the description herein that the invention is not so limited. For example, gateway 150b may transmit the data block to one or more intermediate gateways (not shown) similar to gateways 150a and 150b over a network connection. The intermediate gateway may then transmit the data block to gateway 150a over the network connection.

Additionally, whether the data to be transfer from computer 130b to computer 130a is sufficiently large, it may be necessary that gateway 150b generate and transmit multiple data blocks during the session. Gateway 150b may generate and transmit multiple data blocks by repeating steps 240, 250, and 260 described above until all of the data requested by computer 130a has been transmitted. It will be understood to one of ordinary skill in the art that when multiple data blocks need to be transmitted, they need not necessarily be transmitted along an identical network path. For example, a first data block may be transmitted along a first network path from gateway 150b to gateway 150a, and a second data block may be transmitted along a second network path from gateway 150b to gateway 150a. Gateway 150b may be operable to select an appropriate network path for transmitting a data block based on available bandwidth and network allocation resources, as described above.

Further, while method 200 describes the generation of data blocks including data from a single session, it will be understood that the invention is not so limited. Gateways 150a and 150b may be utilized as a network device in multiple different sessions simultaneously. The multiple different sessions may correspond to one or more different end-to-end connections between computers 130. Accordingly, when gateway 150b buffers received data and generates a data block, it will be understood that the generated data block may include data from a plurality of different sessions.

The exemplary data transfer systems and methods described herein may provide advantages over conventional data transfer systems as set forth below.

The above-described systems and methods of the present invention provide provided scheduling and optimize transmission of data over dedicated network resources when compared with conventional data transfer systems. Further, the above-described data transfer systems and methods may enable faster data transmission by having relatively little protocol overhead when compared with conventional data transfer between network devices. Overhead is minimized due to the transmission of one or a few large data blocks in place of a multitude of small, individualized data units.

Additionally, the systems and methods described herein optimize network performance through effective buffer management and framing techniques enabled by a general session-layer protocol. By generating data blocks based on available bandwidth and timing at buffering gateways within the network, the above-described systems and methods enable the optimal transmission of these data blocks over dedicated network links with minimal overhead. The disclosed systems and methods achieve significantly faster data transfer rates and significant improvement in network utilization compared to conventional data transfer systems.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of transferring data comprising the steps of:
initiating a session for transferring data, the session having a session-layer protocol;
establishing a session connection between a first gateway and a second gateway;
buffering a predetermined amount of data received by the first gateway;
generating a data block using the session-layer protocol when the predetermined amount of data is buffered, the data block including the buffered data; and
transmitting the data block from the first gateway to the second gateway over the session connection.

2. The method of claim 1, wherein the buffering step comprises:
buffering the predetermined amount of data received by the first gateway, the predetermined amount of data dependent on a bandwidth allocated to the session connection.

3. The method of claim 1, wherein the generating step comprises:
encoding at least portions of individual data units of the buffered data to generate the data block using the session-layer protocol.

4. The method of claim 3, wherein the individual data units are packets.

5. The method of claim 4, wherein the packets comprise packets from at least two different sessions.

6. The method of claim 3, further comprising the steps of:
generating control information about the data block at the first gateway;
transmitting the control information from the first gateway to the second gateway; and
decoding the data block into the portions of the individual data units at the second gateway using the control information.

7. The method of claim 6, wherein the step of transmitting the control information comprises:
transmitting the control information from the first gateway to the second gateway over a connection separate from the session connection.

8. The method of claim 1, wherein the generating step comprises:
generating the data block using the session-layer protocol when at least 100 megabytes of data are buffered.

9. The method of claim 1, wherein the step of transmitting the data block comprises:
allocating bandwidth to the session connection when the data block is generated; and
transmitting the data block from the first gateway to the second gateway using the bandwidth allocated to the session connection

10. The method of claim 1, wherein the step of transmitting the data block comprises:
transmitting the data block from the first gateway to a third gateway over the session connection; and
transmitting the data block from the third gateway to the second gateway over the network connection.

11. The method of claim 1, further comprising the step of:
receiving a request from the second computer to initiate the session.

12. A system for transferring data comprising:
a first gateway operable to initiate a session for transferring data and receive data to be transferred, the first gateway including memory for buffering the received data and a processor operable to execute a session-layer protocol for generating a data block including the buffered data when a predetermined amount of data is buffered;
a second gateway; and
a network connecting the first gateway and the second gateway, the first gateway configured to transmit the data block to the second gateway via the network during the session.

13. The system of claim 12, wherein the first gateway generates the data block by encoding at least portions of individual data units of the buffered data using the session-layer protocol.

14. The system of claim 13, wherein the individual data units are packets.

15. The system of claim 14, wherein the packets comprise packets from at least two different sessions.

16. The system of claim 13, wherein:
the first gateway is further operable to generate control information about the data block and transmit the control information to the second gateway; and
the second gateway is operable to decode the data block into the portions of the individual data units using the control information.

17. The system of claim 12, wherein the first gateway generates the data block when at least 100 megabytes of data are buffered in the memory.

18. The system of claim 12, further comprising a third gateway, wherein:
the first gateway is configured to transmit the data block to the third gateway via the network during the session, and
the third gateway is configured to transmit the data block to the second gateway via the network during the session.

19. The system of claim 12 further comprising:
a first computer operable to transmit the data to be transferred to the first gateway, and
a second computer operable to receive transferred data from the second gateway.
